(19) United States
(12) Patent Application Publication
(10) Pub. No.: US 2006/0145373 A1
(43) Pub. Date: Jul. 6, 2006

(54) Process for producing optical recording medium and light transmitting stamper

(75) Inventors: Kenjirou Kiyono, Tokyo (JP); Tomoyuki Taketomi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Kagaku Media Co. Ltd., Tokyo (JP)

(21) Appl. No.: 11/364,010

(22) Filed: Mar. 1, 2006

Related U.S. Application Data
(63) Continuation of application No. PCT/JP04/16746, filed on Nov. 11, 2004.

(30) Foreign Application Priority Data
Nov. 12, 2003 (JP) 2003-382292

(51) Int. Cl. B29D 11/00

(52) U.S. Cl. 264/1.33; 425/406; 425/810

(57) ABSTRACT

To provide a process for producing a laminated optical recording medium with improved production efficiency, with which in production of an optical recording medium by a 2P process, a resin forming an interlayer and a light transmitting stamper can easily be separated without applying any constrained load. A process for producing a laminated optical recording medium, which comprises applying a precursor of an ultraviolet-curing resin on a recording layer containing an organic dye formed on a polycarbonate substrate, disposing a polypropylene light transmitting stamper comprising a nonpolar member having a concavo-convex shape thereon, curing the ultraviolet-curing resin and then easily separating the light transmitting stamper without applying any constrained load so that the concavo-convex shape is transcribed on the resin layer.

### TECHNICAL FIELD

The present invention relates to a process for producing an optical recording medium and the like. Particularly, it relates to a process for producing an optical recording medium with improved production efficiency, and the like.

### BACKGROUND ART

In recent years, it has been desired to develop an optical recording medium on which information can be recorded at a higher density as compared with a conventional one to record and retrieve a large quantity of data such as a long and high quality animation. Such an optical recording medium on which information can be recorded at a high density may, for example, be DVD-ROM having a laminated structure wherein two recording layers (dual layer) are formed on one medium. Employing such multilayer technology of forming two or more recording layers, it is possible to increase the capacity without changing the recording density per layer.

Such a laminated multilayer optical recording medium is produced usually by a production process called photo polymerization process (hereinafter sometimes referred to as “2P process”). By the 2P process, a two-layer structure optical recording medium is produced, for example, by forming on a transparent first substrate having concaves and convexes for recording track formed thereon, a first recording layer, a first reflective layer, an interlayer having concaves and convexes for record track formed thereon, a second recording layer and a second reflective layer in this order, and finally bonding a second substrate.

In the 2P process, the interlayer is produced usually as follows. First, a light-curing resin material or the like is applied to the first reflective layer, and then a light transmitting stamper having a concavo-convex shape is disposed thereon. Then, the light-curing resin material or the like is cured and then the stamper is separated. In such a manner, the concavo-convex shape is transcribed on the surface of the light-curing resin to form the interlayer. Accordingly, in the 2P process, it is required that the stamper after the light-curing resin is cured is smoothly separated. Namely, if problems in production arise in formation of the interlayer having a concavo-convex shape for record track by the 2P process, such that the light-curing resin for the interlayer is cured while the stamper adhered thereto, that the stamper is hardly separated from the light-curing resin, or that uniformity on the surface of the interlayer decreases even if the stamper is separated therefrom, optical information can not stably be recorded and retrieved on the optical recording medium. In order that the light-curing resin and the stamper are easily separated, for example, a method of preliminarily coating the surface of the stamper with a transparent inorganic material such as SiO₂, has been proposed (Patent Document 1).

Patent Document 1: JP-A-2002-279707 (e.g. paragraph (0026)).

### DISCLOSURE OF THE INVENTION

### PROBLEMS THAT THE INVENTION IS TO SOLVE

To preliminarily coat the surface of a stamper used in the 2P process with a transparent inorganic material as in the method disclosed in Patent Document 1, the following step is required. That is, it is required to form a dielectric film made of an inorganic material such as SiO₂ in a predetermined thickness on grooves/information pits formed on the surface of a resin stamper by e.g. a vacuum sputtering apparatus. This step makes the process for producing an optical recording medium complicated, and is one cause of the increase in production cost.

The present invention is to solve such technical problems which appeared in production of a laminated multilayer optical recording medium by the 2P process.

Namely, the object of the present invention is to provide a process for producing a laminated multilayer optical recording medium with improved production efficiency.

Further, another object of the present invention is to provide a light transmitting stamper to be used for production of a laminated multilayer optical recording medium by the 2P process.

### MEANS OF SOLVING THE PROBLEM

To solve such problems, in the present invention, a light transmitting stamper made of a nonpolar member is used in a process for producing an optical recording medium by the 2P process. Namely, the process for producing an optical recording medium to which the present invention is applied comprises a step of forming on a substrate a recording layer on which information is to be recorded by applied light directly or via another layer, a step of forming a resin material layer on the formed recording layer directly or via another layer, and a step of disposing a light transmitting stamper comprising a nonpolar member having a concavo-convex shape on the formed resin material layer and separating the light transmitting stamper so that the concavo-convex shape is transcribed on the resin material layer to form an interlayer.

In the process for producing an optical recording medium to which the present invention is applied, the nonpolar member is a polymer material having no polar group in its molecule. This makes it possible that a resin layer to be formed from e.g. an ultraviolet-curing resin of the optical recording medium and the light transmitting stamper can easily be separated without applying a constrained load. Resultingly, deformation of the recording layer or the like can be prevented, and signal waveform for recording/retrieving optical information can be stabilized. Further, the residue of the ultraviolet-curing resin hardly adheres to the light transmitting stamper, whereby the light transmitting stamper can be recycled.

The nonpolar member is preferably a polyolefin, and among polyolefins, it is preferably a crystalline polyolefin. Further, among crystalline polyolefins, it is preferably a polypropylene. When the above material is employed, the effects of the present invention will favorably be obtained.

In the process for producing an optical recording medium to which the present invention is applied, the light transmitting stamper is preferably made of a nonpolar polymer material having a melt flow rate (MFR) in a molten state of at least 20 g/10 min. When MFR of the nonpolar polymer material is within this range, the light transmitting stamper is likely to be easily formed by e.g. injection molding.

In the process for producing an optical recording medium to which the present invention is applied, the outer diameter of the light transmitting stamper is preferably larger than the outer diameter of the substrate. In this case, the outer diameter of the light transmitting stamper is larger than the outer diameter of the substrate preferably by a range of at least 1 mm and at most 15 mm. When the outer diameter of the light transmitting stamper is larger than the outer diameter of the substrate, even when an outer burr is generated in production of the interlayer, the outer burr will easily be removed.

Further, in the process for producing an optical recording medium to which the present invention is applied, it is preferred that another resin material layer different from the resin material layer formed on the recording layer directly or via another layer, is formed on the surface having the concavo-convex shape of the light transmitting stamper, and the light transmitting stamper is disposed so that said another resin material layer and the resin material layer formed on the recording layer directly or via another layer face each other. By employing the above production process, the outer burr which may be generated in production of the interlayer will more easily be removed. Further, by employing the above production process, an interlayer having a favorable edge shape will easily be obtained.

Further, in the process for producing an optical recording medium to which the present invention is applied, the resin material layer is preferably made of a radiation-curing resin. By employing the radiation-curing resin, the concavo-convex shape of the light transmitting stamper will easily be transcribed. Further, it is preferred that before the light transmitting stamper is separated, light is applied to the resin material layer to cure the radiation-curing resin in the resin material layer to form the interlayer.

In the process for producing an optical recording medium to which the present invention is applied, if the interlayer extends beyond the outer diameter of the substrate, the interlayer portion extending beyond the outer diameter of the substrate is preferably removed. By removing such an interlayer portion, the edge shape of the interlayer can be made favorable. Further, the interlayer portion extending beyond the outer diameter of the substrate is removed preferably by application of a laser beam. By use of a laser beam, accuracy of the edge shape of the interlayer will be more improved.

In the process for producing an optical recording medium to which the present invention is applied, it is preferred that a knife edge is inserted between the substrate and the light transmitting stamper to separate the light transmitting stamper. Further, when the substrate and the light transmitting stamper have a planer circular shape, the knife edge is inserted preferably from the inner diameter side of the substrate and the light transmitting stamper. By use of a knife edge, the light transmitting stamper will easily be separated. Further, it is preferred that the thickness of the light transmitting stamper is made thin at a portion where the knife edge is inserted. This makes it easy to insert the knife edge.

The process for producing an optical recording medium to which the present invention is applied preferably further comprises a step of forming another recording layer on which information is to be recorded by applied light, on the interlayer having the concavo-convex shape transcribed thereon directly or via another layer. This makes it possible to produce a laminated multilayer optical recording medium efficiently.

Further, the present invention provides a light transmitting stamper to be used for a process for producing an optical recording medium comprising a step of forming an interlayer by a photo polymerization process, which is formed from a nonpolar member having a transmittance of a light having a wavelength of from 300 nm to 400 nm of at least 10%. The light transmitting stamper has a thickness of preferably from 0.3 mm to 5 mm. When the thickness of the light transmitting stamper is within the above range, the ultraviolet-curing resin or the like can efficiently be cured, and the productivity will improve. Further, the outer diameter of the light transmitting stapmer is larger than the outer diameter of the optical recording medium. When the outer diameter of the light transmitting stamper is larger than the outer diameter of the optical recording medium, even if an outer burr is generated in production of the interlayer, it will easily be removed.

### EFFECTS OF THE INVENTION

According to the present invention, the production efficiency of a laminated multilayer optical recording medium by a 2P process will improve.

### BRIEF EXPLANATION OF THE DRAWINGS

FIG. 1 is drawing illustrating the process for producing an optical recording medium to which the present embodiment is applied.

FIG. 2 is a graph illustrating the result of measurement of the light transmittance of a light transmitting stamper made of a polypropylene at a wavelength of from 200 nm to 500 nm.

FIG. 3 is drawing illustrating one example of disposition and separation of a light transmitting stamper.

FIG. 4 is drawing illustrating another example of disposition and separation of a light transmitting stamper.

FIG. 5 is drawing illustrating still another example of disposition and separation of a light transmitting stamper.

FIG. 6 is drawing illustrating one example of laser trimming and separation of a light transmitting stamper.

FIG. 7 is drawing illustrating another example of laser trimming and separation of a light transmitting stamper.

FIG. 8 is a perspective view and a cross-sectional view illustrating one example of a state where a light transmitting stamper is disposed.

FIG. 9 is drawing illustrating one example of a method of separating a light transmitting stamper and a data substrate.

FIG. 10 is a drawing illustrating another example of a method of separating a light transmitting stamper and a data substrate.

### EXPLANATION OF SYMBOLS

100: Optical recording medium
101: First substrate
102: First recording layer
103: First reflective layer
301a, 401a, 501a: Outer burr resin material layer
104a, 304a, 404a, 504a (504a1, 504a2): Resin material layer
301, 401, 501, 601, 701: Outer burr
104, 304, 404, 504, 5044, 604, 704, 804, 904, 1004: Interlayer
505a: Outer resin material layer
505, 705: Outer interlayer
105: Second recording layer
106: Second reflective layer
107: Adhesive layer
108: Second substrate
109: Laser beam
110, 310, 410, 510, 610, 710, 810, 910, 1010: Light transmitting stamper
111: Data substrate
420a, 420b, 520a, 520b, 811: Arrow
920, 1020: Knife edge

### BEST MODE FOR CARRYING OUT THE INVENTION

Now, best mode of carrying out the invention (hereinafter referred to as embodiment of the invention) will be explained in detail below. However, needless to say, the present invention is not limited to the following embodiment, and various modifications are possible within a range of the gist.

Preferred Mode of the Process For Producing An Optical Recording Medium to Which the Present Mode is Applied

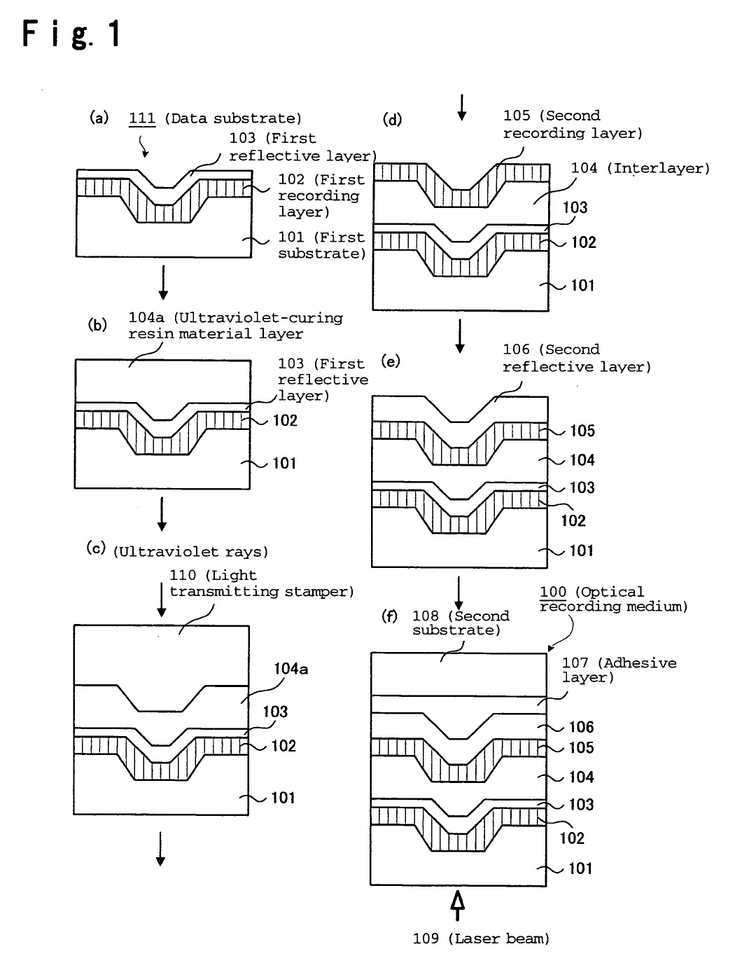

FIG. 1 is drawings illustrating one preferred example of the process for producing an optical recording medium to which the present embodiment is applied. FIG. 1 illustrates, as an example of a process for producing a laminated multilayer optical recording medium, a process for producing a dual layer type one-side incident type optical recording medium (dual DVD-R or dual DVD recordable disk) having two recording layers containing an organic pigment.

A dual optical recording medium 100 as represented by a dual DVD-R as shown in FIG. 1(f) comprises a disk-shape light transmitting first substrate 101, and a first recording layer 102 containing a dye, a translucent first reflective layer 103, a light transmitting interlayer 104 made of an ultraviolet-curing resin, a second recording layer 105 containing a dye, a second reflective layer 106, an adhesive layer 107 and a second substrate 108 forming an outermost layer, laminated in this order on the first substrate 101. On each of the first substrate 101 and the interlayer 104, concaves and convexes are formed and constitute recording trucks. Recording/retrieving of optical information on the optical recording medium 100 as a dual DVD-R is carried out by a laser beam 109 applied to the first recording layer 102 and the second recording layer 105 from the first substrate 101 side.

In the process for producing an optical recording medium to which the present embodiment is applied, “light transmitting (or transparent)” means a light transmittance at a wavelength of light applied to record/retrieve optical information on the first recording layer 102 and the second recording layer 105 containing a dye. Specifically, it means a transmittance of usually at least 30%, preferably at least 50%, more preferably at least 60%, at a wavelength of light for recording/retrieving. On the other hand, the transmittance at a wavelength of light for recording/retrieving is ideally 100%, but is usually a value of 99.9% or below.

As shown in FIG. 1(a), a first substrate 101 having grooves, lands or prepits formed on the surface by concaves and convexes is prepared by e.g. injection molding using e.g. a nickel stamper. Then, a coating liquid containing an organic dye is applied to the surface having concaves and convexes of the first substrate 101 by spin coating or the like. Then, heating or the like is carried out to remove a solvent used for the coating liquid, to form a first recording layer 102. After the first recording layer 102 is formed, a first reflective layer 103 is formed on the first recording layer 102 by sputtering or deposition of a Ag alloy or the like. Such a product prepared by laminating the first recording layer 102 and the first reflective layer 103 laminated in this order on the first substrate 101 is referred to as a data substrate 111. In this case, the data substrate 111 is transparent.

Then, as shown in FIG. 1(b), a precursor of an ultraviolet-curing resin which is one of radiation-curing resins, for example, is applied to the entire surface of the first reflective layer 103 by spin coating or the like, to form a resin material layer (hereinafter referred to as “ultraviolet-curing resin material layer” for convenience of explanation) 104a. In the present invention, “radiation” includes electron radiation, ultraviolet radiation, visible radiation and infrared radiation.

In this case, the precursor of an ultraviolet-curing resin is applied directly to the data substrate 111, but the process is not limited thereto. For example, another layer may be formed on the data substrate 111. The number of revolutions for spin coating is usually at a level of from 500 to 6,000 rpm.

In the present embodiment, an ultraviolet-curing resin is used as an example of a material of the resin material layer. However, the material of the resin material layer is not limited to an ultraviolet-curing resin, and a thermosetting resin may, for example, be also used.

Then, as shown in FIG. 1(c), a light transmitting stamper 110 having a concavo-convex shape is disposed on the ultraviolet-curing resin material layer 104a. In such a state, ultraviolet rays are applied from the light transmitting stamper 110 side via the light transmitting stamper 110 to cure the ultraviolet-curing resin. After the ultraviolet-curing resin is sufficiently cured, the light transmitting stamper 110 is separated. By the above operation, an interlayer 104 (FIG. 1(d)) on which concaves and convexes of the light transmitting stamper 110 are transcribed is formed on the surface of the ultraviolet-curing resin. Disposition of the light transmitting stamper 110 is adjusted so that the thickness of the ultraviolet-curing resin material layer 104a will be within a predetermined range. Application of ultraviolet rays to cure the ultraviolet-curing resin material layer 104a is not limited to application from the light transmitting stamper 110 side. For example, application from the side surface of the ultraviolet-curing resin material layer 104a may, for example, be mentioned.

The light transmitting stamper 110 used in the present embodiment comprises a nonpolar member having a concavo-convex shape on the surface. By using the light transmitting stamper 110 comprising a nonpolar member, the interlayer 104 and the light transmitting stamper 110 can easily be separated without applying a constrained load. Resultingly, a possibility of deformation of the first recording layer 102 and the first reflective layer 103 reduces. Further, the uniformity on the surface of the interlayer 104 tends to be maintained, whereby signal waveform for recording/retrieving of optical information will be stabilized. Further, a residue of the ultraviolet-curing resin hardly adheres to the light transmitting stamper 110 side, whereby the light transmitting stamper 110 is likely to be recycled.

Here, “polar” means a state where electrons are locally present in a molecule and there is unevenness of charge. Further, “nonpolar” means a state where there is not such unevenness of charge.

The nonpolar member constituting the light transmitting stamper 110 may, for example, be an inorganic material or an organic material. The inorganic material may, for example, be inorganic glass. The organic material may, for example, be a polymer material having no polar group in its molecule. Particularly, when the light transmitting stamper 110 is formed by using a polymer material having no polar group in its molecule, it can be prepared by using a metal stamper (such as a nickel stamper) having a negative concavo-convex pattern by injection molding or the like.

Such a polar group may, for example, be a polar group containing an oxygen atom, a polar group containing a nitrogen atom, a polar group containing a sulfur atom or a polar group containing a halogen atom. Specifically, the polar group containing an oxygen atom may, for example, be a hydroxyl group, an ether group, an aldehyde group, a carbonyl group, an acetyl group, a carboxyl group or an ester group. The polar group containing a nitrogen group may, for example, be an amino group, an imino group, an ammonium group, an amide group, an imide group, a nitro group, a nitroso group, a diazo group or an acrylonitro group. The polar group containing a sulfur atom may, for example, be a thiol group, a sulfide group or a sulfonic group. The polar group containing a halogen atom may, for example, be a chloro group, a chloromethyl group, a chlorosyl group, a chloryl group, a perchloryl group, a bromo group, an iodo group, an iodosyl group or a fluoro group. In the present invention, it is preferred to use a polymer material having no such polar group in its molecule. Further, the polymer material having no polar group in its molecule preferably has no unsaturated bond such as a carbon-carbon double bond, an aromatic monocyclic hydrocarbon group such as a phenyl group nor a condensed polycyclic hydrocarbon group such as a naphthyl group in its molecule.

Usually, a Coulomb force (electrostatic force) works and the Van der Waals force (intermolecular attraction) is significant between molecules of a polymer material having a polar group in its molecule, since there is unevenness of charge in the polar group. Further, usually, a material to be used for a resin material layer such as an ultraviolet-curing resin has such a structure that a polar group is bonded to the molecule in many cases. In such a case, if a stamper formed from such a polymer material having a polar group in its molecule is used, the Van der Waals force between the stamper and the ultraviolet-curing resin tends to be significant, and the stamper and the ultraviolet-curing resin tend to be hardly separated. Accordingly, by use of a stamper made of a polymer material having no polar group in its molecule, the Van der Waals force tends to reduce, and the adhesion with the ultraviolet-curing resin tends to be weak. It is considered that the stamper and the ultraviolet-curing resin will easily be separated resultingly.

Here, the “polymer material having no polar group in its molecule” ideally means a polymer having no polar group at all in the basic structure of the polymer.

The polymer material having no polar group in its molecule may, for example, be a polyolefin. The polyolefin has a simple structure consisting of carbon and hydrogen and thereby shows nonpolar characteristics. Accordingly, the polyolefin is easily separated from a radiation-curing resin such as an ultraviolet-curing resin or a thermosetting resin. Further, the polyolefin has such an advantage that it has a high light transmittance of a light having a short wavelength required for curing the radiation-curing resin. Further, the polyolefin also has such an advantage that no harmful gas or the like is discharged even if it is burned at the time of disposal after use, whereby it puts less burden on the environment.

The polyolefin can be classified into a crystalline polyolefin and an amorphous polyolefin.

More specifically, the polyolefin may, for example, be a polymer of an α-olefin or a polymer of a cyclic olefin. The polymer of an α-olefin may, for example, be a polyethylene, a polypropylene, an ethylene/propylene copolymer, or a copolymer of ethylene and an α-olefin having from 4 to 20 carbon atoms. Such an α-olefin having from 4 to 20 carbon atoms may, for example, be 1-butene, 1-pentene, 1-hexene, 4-methyl-1-pentene, 1-heptene, 1-octene, 1-nonene, 1-decene, 1-undecene, 1-dodecene, 9-methyl-1-decene, 11-methyl-1-dodecene, 1-tetradecene, 1-hexadecene, 1-octadecene or 1-eicocene. The polymer of a cyclic olefin may, for example, be an amorphous polyolefin which is a hydrogenated product of a ring-opening polymer of a tetracyclododecene and a dicyclopenatadiene.

Among the polyolefins, a polyethylene, a polypropylene, an ethylene/propylene copolymer or an amorphous polyolefin is preferred. A polyethylene, a polypropylene and an ethylene/propylene copolymer are slightly poor in transparency since they are highly crystalline, but they can be formed at a low cost. Particularly, a polypropylene and an ethylene/propylene copolymer, which are excellent also in heat resistance and fatigue resistance (hinge properties), are preferred. Most preferred is a polypropylene.

Further, the amorphous polyolefin is excellent in transparency and precision moldability due to its amorphous properties. The amorphous polyolefin is preferably commercial products by the tradenames of ZEONEX and ZEONOR (manufactured by ZEON CORPORATION), for example.

The crystalline polyolefin such as a polyethylene, a polypropylene or an ethylene/propylene copolymer is widely used as a general molding material. Accordingly, the crystalline polyolefin can be available at a lower cost than the amorphous polyolefin. Accordingly, by use of the crystalline polyolefin, the cost for production of a laminated multilayer optical recording medium can be reduced.

Further, such a crystalline polyolefin is excellent in fatigue resistance (hinge properties) as compared with an amorphous polyolefin. The following advantages will be obtained due to excellence in fatigue resistance (hinge properties) of a crystalline polyolefin. That is, the light transmitting stamper is partially deformed in a step of separating the light transmitting stamper. Thus, when the light transmitting stamper is used repeatedly, the light transmitting stamper is deformed repeatedly. A light transmitting stamper prepared from a crystalline polyolefin is excellent in fatigue resistance (hinge properties) as compared with a light transmitting stamper prepared from an amorphous polyolefin, and is less likely to be cracked even if it is repeatedly used and repeatedly deformed.

Among the above crystalline polyolefins, a polypropylene or an ethylene/propylene copolymer, which is particularly excellent in fatigue resistance (hinge properties) and heat resistance, is preferred.

With respect to the fluidity of the nonpolar member, the melt flow rate (MFR) in a molten state is at least 20 g/10 min., preferably at least 30 g/10 min., more preferably at least 40 g/10 min. However, it is usually at most 100 g/10 min. When the fluidity of the nonpolar member is within this range, excellent transcribability of the concavo-convex shape will be obtained. That is, when MFR is within the above range, a stamper can easily be formed by injection molding or the like.

Here, MFR represents a value measured within a temperature range of at least the melting point and at most the decomposition temperature of the nonpolar member at a load of 21.18 N in accordance with ISO1133. Particularly with respect to a polypropylene and an ethylene/propylene copolymer, it is a value measured at a temperature of 230° C. in accordance with JIS K6921-1.

Further, with respect to the light transmittance of the nonpolar member, the transmittance of a test specimen with a thickness of 0.6 mm of a light having a wavelength of from 300 to 400 nm is usually at least 10%, preferably at least 30%, more preferably at least 50%. On the other hand, the transmittance of the nonpolar member is preferably as high as possible, but is usually 99.9% or below.

Further, when the polymer material is used as the nonpolar member, the light transmitting stamper may contain, in addition to the nonpolar polymer material, a small amount of a releasing agent, an antistatic agent or impurities. In such a case, the proportion of the nonpolar polymer material in the light transmitting stamper is preferably at least 95 wt %, more preferably at least 98 wt %, most preferably at least 99 wt %. However, when a material other than the nonpolar polymer material is used, the upper limit of the content of the nonpolar polymer material is usually 99.999 wt %.

The light transmitting stamper 110 used in the present embodiment preferably has a thickness of usually at least 0.3 mm in view of form stability and easiness of handling. However, the thickness is usually at most 5 mm. When the thickness of the light transmitting stamper 110 is within this range, the stamper has sufficient light transmittance, whereby the ultraviolet-curing resin or the like can be efficiently cured even when ultraviolet rays are applied via the light transmitting stamper 110, and the productivity will improve.

The outer diameter of the light transmitting stamper 110 is preferably larger than the outer diameter of the first substrate 101 (outer diameter of the optical recording medium 100). When the outer diameter of the light transmitting stamper 110 is preliminarily designed to be larger than the outer diameter of the first substrate 101, the concavo-convex shape can be formed even on the peripheral portion of the light transmitting stamper 110 extending beyond the outer diameter of the first substrate 101 with a good margin at the time of injection molding, whereby the concavo-convex shape can be favorably formed over the entire surface of the light transmitting stamper 110. Further, when the outer diameter of the light transmitting stamper 110 is larger than the outer diameter of the first substrate 101, the outer diameter of the light transmitting stamper 110 becomes larger than the outer diameter of the interlayer 104 (ultraviolet-curing resin material layer 104a). This makes it possible that the shape of the edge surface of the interlayer 104 is favorable. That is, when the light transmitting stamper 110 is disposed on the ultraviolet curing resin material layer 104a, a resin of the ultraviolet-curing resin material layer 104a may adhere to the outer peripheral portion of the light transmitting stamper 110. This resin may form a burr when the light transmitting stamper is separated. Accordingly, when the outer diameter of the light transmitting stamper 110 is larger than the outer diameter of the interlayer 104 (ultraviolet-curing resin material layer 104a), the resin present at the edge of the ultraviolet-curing resin material layer 104a which is likely to form a burr is present beyond the outer diameter of the interlayer 104. As a result, even if a burr is generated, a portion where the burr is generated can be removed so as to obtain a favorable shape of the edge of the interlayer 104.

Specifically, the outer diameter of the light transmitting stamper 110 is larger than the outer diameter of the first substrate 101 by usually at least 1 mm, preferably at least 2 mm by diameter. However, it is usually at most 15 mm, preferably at most 10 mm by diameter.

Then, as shown in FIG. 1(d), a coating liquid containing an organic dye is applied to the surface of the interlayer 104 by spin coating or the like. Then, heating or the like is carried out to remove a solvent used for the coating liquid to form a second recording layer 105. In such a case, the heating temperature is preferably at least the glass transition temperature of the resin constituting the interlayer 104. By heating at the above temperature, it is possible to suppress warpage of the first substrate 101 considered to be due to shrinkage of the interlayer 104. In the present embodiment, the second recording layer 105 is formed directly on the interlayer 104. However, needless to say, the second recording layer 105 may be formed via another layer (such as a protective layer or a buffer layer). By the above step, a laminated multilayer optical recording medium can be efficiently produced.

Then, as shown in FIG. 1(e), a second reflective layer 106 is formed on the second recording layer 105 by depositing a Ag alloy or the like by sputtering. Then, as shown in FIG. 1(f), a second substrate 108 as a mirror substrate obtained by injection molding of a polycarbonate is bonded to the second reflective layer 106 via an adhesive layer 107 to complete production of the optical recording medium 100.

The adhesive layer 107 may be translucent or may have a slightly rough surface, and further, a delayed curing adhesive may also be used without any problem. For example, the adhesive layer 107 can be formed by applying an adhesive to the second reflective layer 106 by screen printing or the like, applying ultraviolet rays thereto, and then disposing the second substrate 108, followed by pressing. Further, the adhesive layer 107 may be formed also by interposing a pressure sensitive double coated adhesive tape between the second reflective layer 106 and the second substrate 108, followed by pressing.

The layer structure shown in FIG. 1(f) illustrates one example of an optical recording medium having two recording layers as mentioned above. Accordingly, needless to say, another layer not shown in FIG. 1(f) may be used (for example, a primary layer is inserted between the first substrate 101 and the first recording layer 102).

More Preferred Mode of the Process for Producing an Optical Recording Medium to Which the Present Mode is Applied

In the present mode, the outer diameter of the light transmitting stamper is preferably larger than the outer diameter of the first substrate. This will be explained in further detail below with reference to the disposition and separation of the light transmitting stamper.

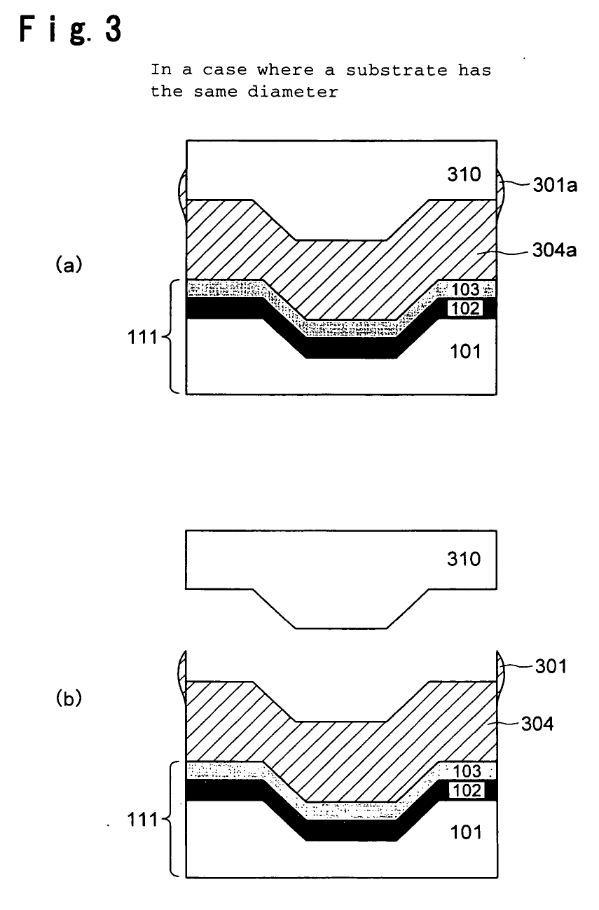

FIG. 3 is drawings illustrating one example of disposition and separation of a light transmitting stamper. FIG. 3 illustrates one example of disposition of a light transmitting stamper 310 and a state after separation of the light transmitting stamper 310 in a case where the outer diameter of the light transmitting stamper 310 is the same as the outer diameter of the first substrate 101 and thus the outer diameter of a data substrate 111. The data substrate 111 has such a structure that on a first substrate 101, a first recording layer 102 and a first reflective layer 103 are laminated in this order.

As shown in FIG. 3(a), when the light transmitting stamper 310 is disposed on a resin material layer 304a, the resin material layer 304a may protrude toward the light transmitting stamper side to form an outer burr resin material layer 301a. This happens because the resin material layer 304a (usually formed from an ultraviolet-curing resin) has not been cured yet but has fluidity. Then, as shown in FIG. 3(b), the resin material layer 304a (FIG. 3(a)) and the outer burr resin material layer 301a (FIG. 3(a)) are cured and then the light transmitting stamper 310 is separated, whereby an outer burr 301 is formed on the interlayer 304. This outer burr 301 is formed in a region very close to the outer diameter of the data substrate 111 since the outer diameter of the light transmitting stamper 310 and the outer diameter of the data substrate 111 are the same. Further, the outer burr 301 is very small as compared with the size of the interlayer 304. For example, the diameter of the interlayer 304 is 120 mm, whereas the size of the outer burr 301 is at a level of several tens μm. Accordingly, it may be industrially difficult to remove only the outer burr 301 to obtain a favorable edge shape of the interlayer 304 in some cases.

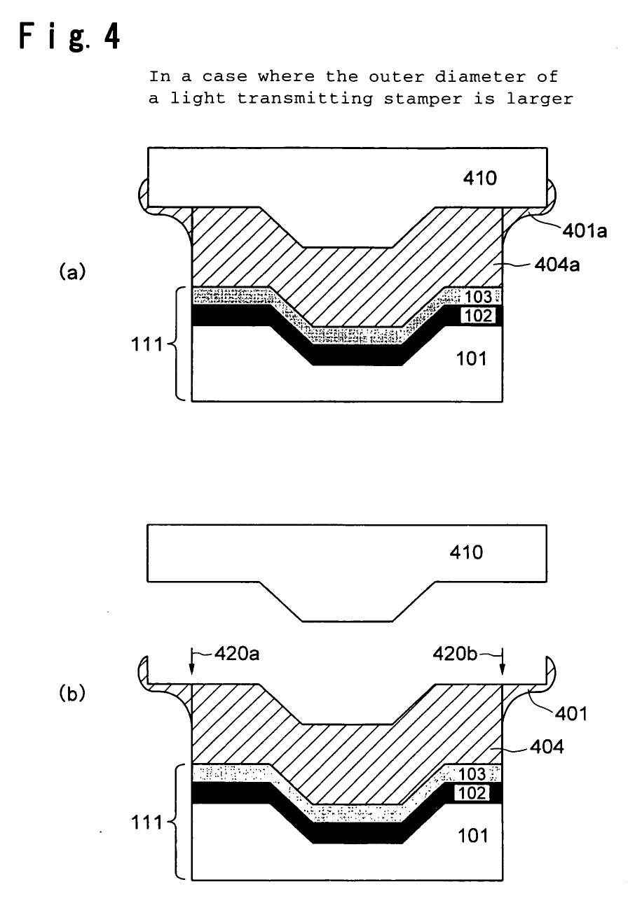

In a case where such an outer burr 301 is generated, the outer diameter of the light transmitting stamper 310 is preferably larger than the outer diameter of the first substrate 101 and thus the outer diameter of the data substrate 111. This will be explained below with reference to FIG. 4.

FIG. 4 is drawings illustrating another example of disposition and separation of a light transmitting stamper. FIG. 4 illustrates one example of disposition of a light transmitting stamper 410 and a state after separation of the light transmitting stamper 410 in a case where the outer diameter of the light transmitting stamper 410 is larger than the outer diameter of a first substrate 101 and thus the outer diameter of a data substrate 111. The data substrate 111 has such a structure that on the first substrate 101, a first recording layer 102 and a first reflective layer 103 are laminated in this order.

In FIG. 4(a), the outer diameter of the light transmitting stamper 410 is larger than the first substrate 101 and thus the data substrate 111. Accordingly, when the light transmitting stamper 410 is disposed on a resin material layer 404a, the edge of the resin material 404a extends and protrudes toward the outer peripheral direction of the light transmitting stamper 410 to form an outer burr resin material layer 401a. This happens because the resin material layer 404a (usually formed from an ultraviolet-curing resin) has not been cured yet but has fluidity.

Since the outer diameter of the light transmitting stamper 410 is larger than the data substrate 111, the outer burr resin material layer 401a largely extends beyond the outer diameter of the data substrate 111. Then, as shown in FIG. 4(b), the resin material layer 404a (FIG. 4(a)) and the outer burr resin material layer 401a (FIG. 4(a)) are cured and then the light transmitting stamper 410 is separated, whereby an outer burr 401 is formed on the interlayer 404. This outer burr 401 largely extends beyond the outer diameter of the data substrate 111 (outer diameter of the interlayer 404) similarly to the outer burr resin material layer 401a (FIG. 4(a)). Accordingly, it tends to be easy to remove the outer burr 401 present in a region outside arrows 420a and 420b to obtain a favorable edge shape of the interlayer 404.

Specific examples wherein a favorable edge shape of the interlayer 404 tends to be easily obtained in a case where the outer diameter of the light transmitting stamper 410 is larger than the outer diameter of the first substrate 101 and thus the outer diameter of the data substrate 111, will be further explained below.

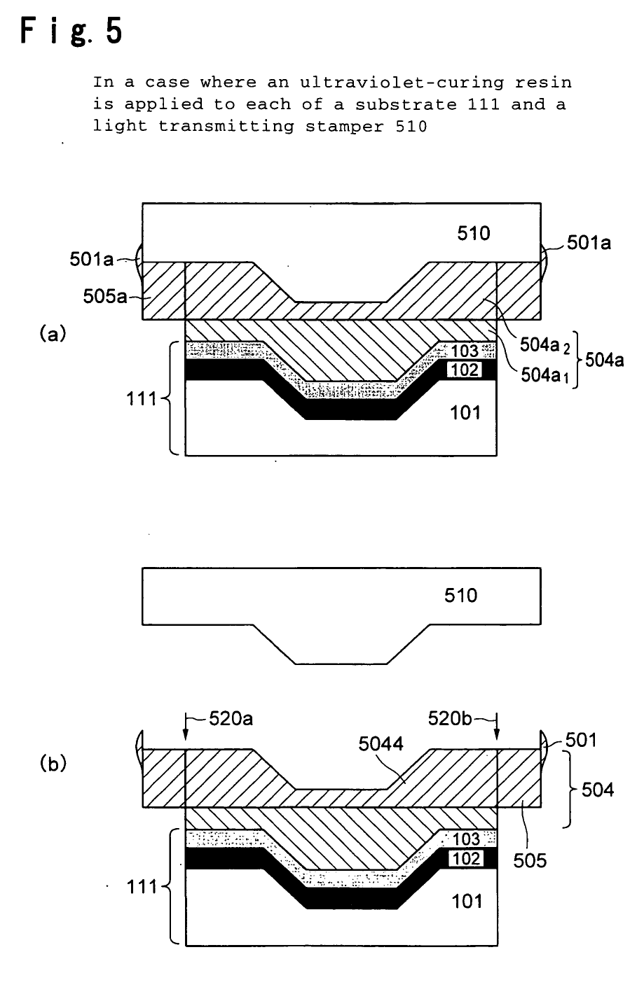

FIG. 5 is drawings illustrating still another example of disposition and separation of a light transmitting stamper. FIG. 5 illustrates one example of disposition of a light transmitting stamper 510 and a state after separation of the light transmitting stamper 510 in a case where the outer diameter of the light transmitting stamper 510 is larger than the outer diameter of a first substrate 101 and thus the outer diameter of a data substrate 111. The data substrate 111 has such a structure that on the first substrate 101, a first recording layer 102 and a first reflective layer 103 are laminated in this order.

In FIG. 5(a), another resin material layer 504a2 is formed on the surface having a concavo-convex shape of the light transmitting stamper 510. The light transmitting stamper 510 is disposed so that the resin material layer 504a2 and a resin material layer 504a1 formed on the data substrate 111 face each other. The resin material layer 504a2 formed on the light transmitting stamper 510 has an outer diameter larger than the outer diameter of the data substrate 111 (first substrate 101) by the dimension of an outer resin material layer 505a. Accordingly, the resin material layer 504a2 largely extends beyond the outer diameter of the data substrate 111. Therefore, an outer burr resin material layer 501a is formed outside the resin material layer 504a2 (outside the outer resin material layer 505a).

Then, as shown in FIG. 5(a), the resin material layer 504a1 (FIG. 5(a)), the resin material layer 504a2 (FIG. 5(a)) and the outer burr resin material layer 501a (FIG. 5(a)) are cured and then the light transmitting stamper 510 is separated, whereby an outer burr 501 is formed on the interlayer 504. The outer burr 501 is formed further outside an outer interlayer 505 largely extending beyond the outer diameter of the data substrate 111. Accordingly, the outer interlayer 505 present outside the outer diameter of the data substrate 111 is likely to be removed from the positions shown by arrows 520a and 520b. As a result, as shown in FIG. 5, an interlayer 5044 having a favorable edge shape is likely to be obtained in view of industrial production.

In FIGS. 4 and 5, the interlayer (the outer burr 401 in FIG. 4(b) or the outer interlayer 505 and the outer burr 501 in FIG. 5(b)) formed beyond the outer diameter of the first substrate 101 and thus the data substrate 111, usually has to be cut off from the interlayer 404 (FIG. 4(b)) or 5044 (FIG. 5(b)) having an outer diameter substantially the same as the outer diameter of the first substrate 101 and thus the data substrate 111, as described above.

Removal of the outer burr 401 (FIG. 4(b)), or the outer interlayer 505 and the outer burr 501 (FIG. 5(b)), formed beyond the outer diameter, may be carried out either before or after separation of the light transmitting stamper 410 or 510. In view of production efficiency and with a view to improving dimensional accuracy of the outer diameter of the interlayer 404 (FIG. 4(b)) or 5044 (FIG. 5(b)), the interlayer formed beyond the outer diameter is removed preferably before separation of the light transmitting stamper 410 or 510. That is, since the interlayer 404 (FIG. 4(b)) or 5044 (FIG. 5(b)) is usually thin (usually at a level of several tens μm), it may be industrially difficult to remove the interlayer with high accuracy in some cases. Further, if the outer burr 401 (FIG. 4(b)) or the outer interlayer 505 and the outer burr 501 (FIG. 5(b)) are removed after separation of the light transmitting stamper 410 or 510, the removed portion is likely to adhere to the optical recording medium as a foreign matter (dust).

The method of removing the interlayer formed beyond the outer diameter of the data substrate 111 or the first substrate 101 (it means the outer burr 401 in FIG. 4(b), or the outer interlayer 505 and the outer burr 501 in FIG. 5(b), and hereinafter both will be referred to as “protruding interlayer” in some cases) is not particularly limited. Such a method may, for example, be a method of dissolving the protruding interlayer with a solvent, a method of mechanically polishing the protruding interlayer, a method of mechanically cutting the protruding interlayer or a method of optically removing the protruding interlayer. Among these methods, preferred is an optical removal method in view of favorable accuracy of the edge shape and industrial usability. The optical removal method is preferably a method of removing the protruding interlayer by application of a laser beam.

That is, for example, a method may be mentioned wherein a laser beam is applied to a space between the protruding interlayer and the outer diameter of the interlayer 404 (FIG. 4(b)) or 5044 (FIG. 5(b)) (the outer diameter substantially the same as the outer diameter of the data substrate 111 or the first substrate 101) to cut off the protruding interlayer and separating it together with the light transmitting stamper 410 or 510 (hereinafter this method will be referred to as “laser trimming” in some cases). The laser used is not particularly limited so long as it can be used in industrial production. Preferred as a laser having a power which will not impair the edge shape of the interlayer 404 (FIG. 4(b)) or 5044 (FIG. 5(b)) and the light transmitting stamper 410 or 510, is a CO₂ laser (wavelength: 10.6 μm). A CO₂ laser output apparatus is not particularly limited so long as it is industrially commonly used. The power of the CO₂ laser is also not particularly limited so long as the protruding portion of the interlayer 404 (FIG. 4(b)) or 5044 (FIG. 5(b)) can be removed, and suitably adjusted.

Further, the laser trimming may be carried out either by rotating the laser with the data substrate 111 on which the interlayer 404 (FIG. 4(b)) or 5044 (FIG. 5(b)) laminated thereon fixed, or by rotating the data substrate 111 on which the interlayer 404 (FIG. 4(b)) or 5044 (FIG. 5(b)) is laminated, with the laser application position fixed. The latter method is industrially simple (the apparatus is likely to be simplified).

Now, one specific example of the laser trimming will be explained below.

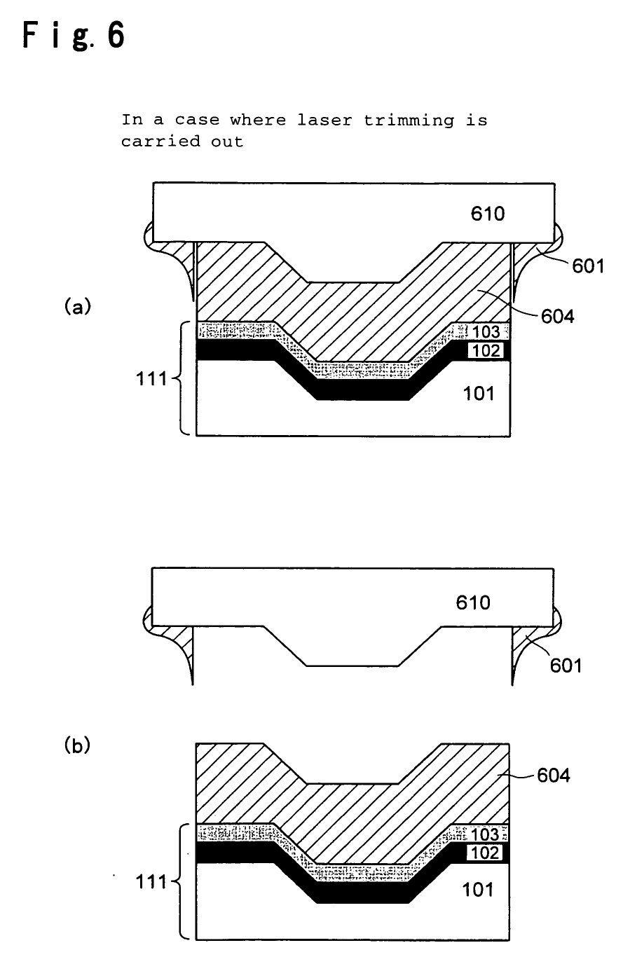

FIG. 6 is drawings illustrating one example of laser trimming and separation of a light transmitting stamper. FIG. 6(a) is a drawing illustrating such a state that a light transmitting stamper 610 is disposed on a resin material layer (not shown in FIG. 6(a)) as shown in FIG. 4(a), and then the resin material layer (not shown in FIG. 6(a)) is cured to form an interlayer 604, and then the protruding interlayer (outer burr 601) is removed by laser trimming. FIG. 6(b) illustrates a state where the light transmitting stamper 610 is separated after the laser trimming. A data substrate 111 has such a structure that on a first substrate 101, a recording layer 102 and a first recording layer 103 are laminated in this order.

As shown in FIG. 6(a), a laser is applied from a laser application apparatus (not shown in FIG. 6(a)) along the outer diameter of the interlayer 604 (the outer diameter substantially the same as a data substrate 111 or a substrate 101) to form the outer diameter of the interlayer 604. In this case, the outer periphery of the interlayer 604 can be formed, for example, by rotating the data substrate 111. Then, as shown in FIG. 6(b), the light transmitting stamper 610 is separated.

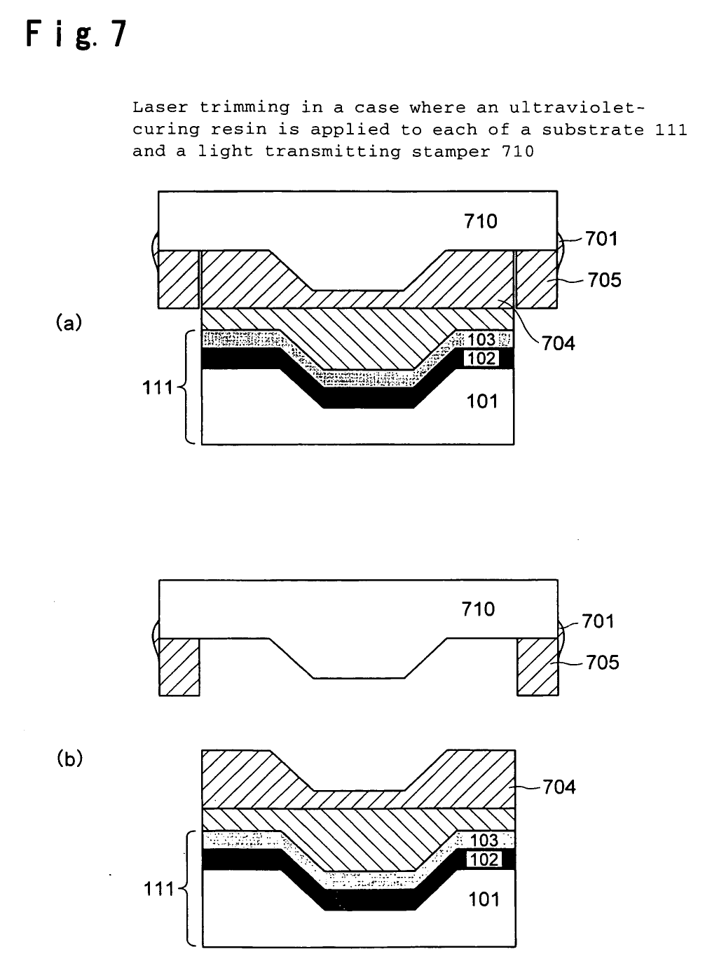

FIG. 7 is drawings illustrating another example of laser trimming and separation of a light transmitting stamper. FIG. 7(a) is a drawing illustrating a state where a light transmitting stamper 710 is disposed on a resin material layer (not shown in FIG. 7(a)) as shown in FIG. 5(a), and then the resin material layer (not shown in FIG. 7(a)) is cured to form an interlayer 704, and then the protruding interlayer (an outer interlayer 705 and an outer burr 701) is removed by laser trimming. FIG. 7(b) illustrates a state where the light transmitting stamper 710 is separated after the laser trimming.

As shown in FIG. 7(a), a laser is applied from a laser application apparatus (not shown in FIG. 7(a)) along the outer diameter of the interlayer 704 (the outer diameter substantially the same as the data substrate 111 or a first substrate 101) to form the outer diameter of the interlayer 704. In this case, the outer periphery of the interlayer 704 can be formed, for example, by rotating the data substrate 111. Then, as shown in FIG. 7(b), the light transmitting stamper 710 is separated. In FIG. 7, the outer interlayer 705 is made large, whereby the protruding interlayer (the outer interlayer 705 and the outer burr 701) is easily removed.

Now, the method of separating the light transmitting stamper will be explained in detail below. The method of separating the light transmitting stamper is not particularly limited, but preferred is a method of inserting a jig such as a knife edge between the substrate and the light transmitting stamper to separate the light transmitting stamper. By use of a jig such as a knife edge, the light transmitting stamper can be industrially easily separated.

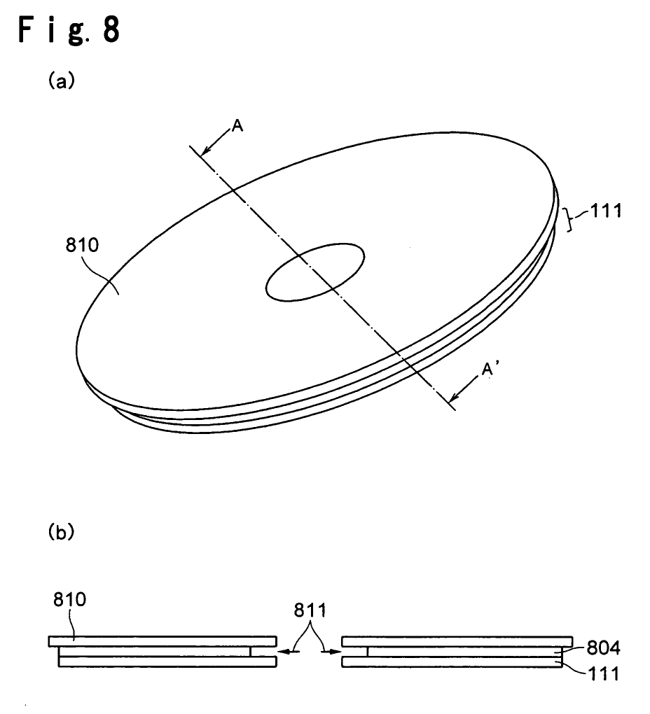

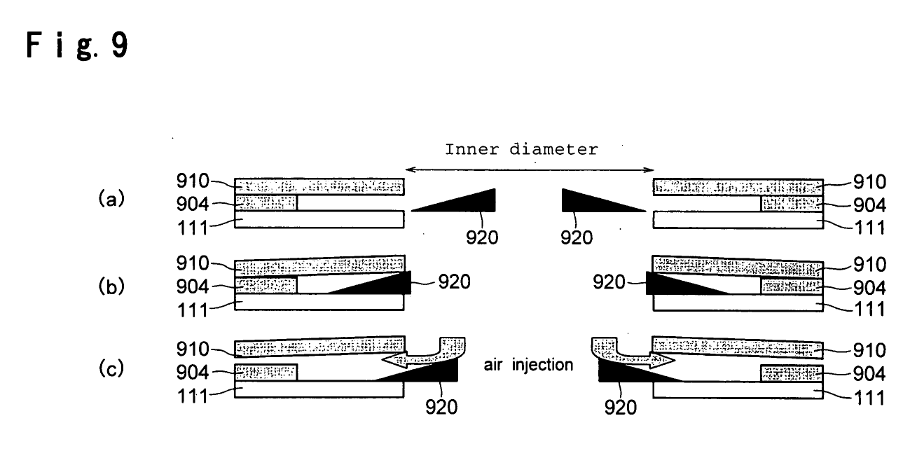

A method of separating the light transmitting stamper by inserting a knife edge, as one example, will be explained with reference to FIGS. 8 and 9 below.

FIG. 8 is a perspective view and a cross-sectional view illustrating one example of a state where a light transmitting stamper is disposed. FIG. 8(a) is a perspective view illustrating a state where a light transmitting stamper 810 having a planer circular shape is disposed on a data substrate 111 having a planer circular shape. FIG. 8(b) is a cross-sectional view at A-A′ in FIG. 8(a). Further, FIG. 9 is drawings illustrating one example of a method of separating a light transmitting stamper and a data substrate. FIG. 9 illustrates the separation of a light transmitting stamper using a knife edge shown in FIG. 8. In FIGS. 8 and 9, no recording layer nor reflective layer are shown for understandability of figures.

In FIG. 8(a), on the data substrate 111 having a planer circular shape, an interlayer 804 having an inner diameter larger than the inner diameter of the substrate 111 is formed. Further, the light transmitting stamper 810 having a planer circular shape, having an inner diameter smaller than the inner diameter of the interlayer 804 and having an outer diameter larger than the outer diameter of the data substrate 111 (interlayer 804) is disposed on the interlayer 804. The planer circular shape means a disk shape having a hole with a predetermined length from the center of the circle, such as CD or DVD (see FIG. 8(a)).

Separation of the light transmitting stamper 810 is carried out by inserting a knife edge between the data substrate 111 and the light transmitting stamper 810 (shown by arrows 811 in FIG. 8(b)) from the inner diameter side of the data substrate 111 and the light transmitting stamper 810. The method of inserting a knife edge from the inner diameter side is a method which is advantageous also in industrial production.

More specifically, as shown in FIGS. 9(a) and 9(b), a knife edge 920 is inserted between the data substrate 111 and the light transmitting stamper 910 to partially separate the light transmitting stamper 910. Then, as shown in FIG. 9(c), the data substrate 111 and the light transmitting stamper 910 are gradually detached while compressed air is injected, to completely separate the light transmitting stamper 910.

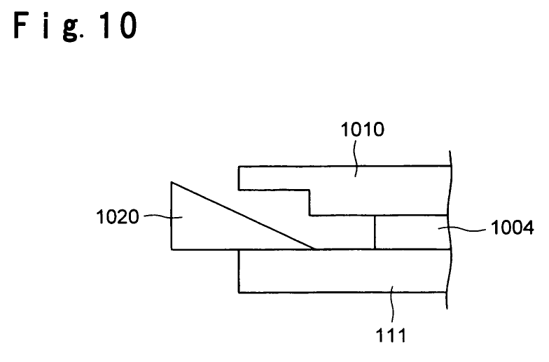

FIG. 10 is a drawing illustrating another example of the method of separating the light transmitting stamper and the data substrate. FIG. 10 is an enlarged cross-sectional view illustrating a laminate comprising a light transmitting stamper 1010, an interlayer 1004 and a data substrate 111 when a knife edge 1020 is inserted. In FIG. 10, no recording layer nor reflective layer is shown for understandability of the figure. As shown in FIG. 10, the light transmitting stamper 1010 at a portion where the knife edge 1020 is inserted is made thin, whereby the knife edge 1020 is favorably inserted.

Optical Recording Medium to Which the Present Embodiment is Applied

In the present embodiment, the process for producing a laminated multilayer optical recording medium has been explained with reference to a dual layer type dual DVD-R having two recording layers containing an organic dye as an example, but is not limited thereto. Namely, effects of the present invention will be favorably obtained so long as the optical recording medium is an optical recording medium or a laminate for an optical recording medium produced by a production process comprising a step of applying a resin material layer on a data substrate directly or via another layer, attaching a light transmitting stamper having a concavo-convex shape thereto and then separating it so that the concavo-convex shape of the light transmitting stamper is transcribed on the resin to form a resin layer. Namely, by use of a light transmitting stamper comprising a nonpolar member, the production process of the present embodiment can be applied to an optical recording medium having another structure.

For example, the production process of the present embodiment can be applied to an optical recording medium having only one recording layer. Further, it can be applied to an optical recording medium having three or more recording layers and having two or more interlayers. In such a case, the production process of the present embodiment can be applied to formation of each of the two or more interlayers. Further, in the above-described embodiment, the process for producing a so-called substrate face incident type optical recording medium has been explained. However, needless to say, it can be applied to a process for producing a so-called film face incident type optical recording medium.

Now, layers constituting a dual optical recording medium 100 as represented by a dual DVD-R as shown in FIG. 1(f) will be briefly explained below.

First Substrate

The first substrate 101 is preferably excellent in optical characteristics such that it has optical transmittance, it has a small birefringence, etc. Further, the first substrate 101 is preferably excellent in moldability such that it can easily be formed by injection molding. Further, the first substrate 101 preferably has small moisture absorption properties. Still further, the first substrate 101 preferably has form stability so that the optical recording medium has a certain level of rigidity. A material constituting the first substrate 101 is not particularly limited, and an acrylic resin, a methacrylic resin, a polycarbonate resin, a polyolefin resin (particularly amorphous polyolefin), a polyester resin, a polystyrene resin, an epoxy resin or glass may, for example, be mentioned. The thickness of the first substrate 101 is usually at most 2 mm, preferably at most 1 mm. When the distance between an objective lens and a recording layer is smaller and the substrate is thinner, coma aberration tends to be small, and the recording density tends to be high. However, the thickness is usually at least 10 μm, preferably at least 30 μm, so as to obtain sufficient optical characteristics, low moisture absorption properties, moldability and form stability.

First Recording Layer

The first recording layer 102 is usually required to have a higher sensitivity as compared with a recording layer used in an optical recording medium to be used for CD-R, dual DVD-R, etc. In the optical recording medium 100 to which the present embodiment is applied, the power of an applied laser beam 109 reduces to half by e.g. presence of a first reflective layer 103 as described hereinafter and recording is carried out at an about half power, and accordingly a particularly high sensitivity is required. Further, as a dye to be used for the first recording layer 102, preferred is a dye compound having a maximum absorption wavelength λmax in a region of visible light at a level of from 350 to 900 nm to an infrared ray, suitable for recording by a blue to near microwave laser. Usually, preferred as the dye compound is, for example, a dye suitable for recording with a near infrared laser having a wavelength at a level of from 770 to 830 nm such as one used for CD-R, a dye suitable for recording with a red laser having a wavelength at a level of from 620 to 690 nm such as one used for DVD-R, or a dye suitable for recording with a so-called blue laser having a wavelength of 410 nm, 515 nm, or the like.

The dye used for the first recording layer 102 is not particularly limited, and usually an organic dye material is used. The organic dye material may, for example, be a macrocyclic azaanulene dye (such as phthalocyanine dye, naphthalocyanine dye or porphyrin dye), a pyrromethene dye, a polymethine dye (such as cyanine dye, merocyanine dye or squarilium dye), an anthraquinone dye, an azulenium dye, a metal-containing azo dye or a metal-containing indoaniline dye. Such dyes may be used alone or as a mixture of two or more of them. The thickness of the first recording layer 102 is not particularly limited since a suitable film thickness varies depending upon the recording method or the like. However, it is usually at least 5 nm, preferably at least 10 nm, particularly preferably at least 20=m, so as to obtain a sufficient degree of modulation. However, it is usually at most 3 μm, preferably at most 1 μm, more preferably at most 200 nm so that light is transmitted. The method of forming the first recording layer 102 is not particularly limited, and usually, a thin film formation method which is commonly carried out, such as a vacuum deposition method, a sputtering method, a doctor blade method, a casting method, a spin coating method or a dipping method may be mentioned. The film formation method is preferably a wet film formation method such as a spin coating method in view of mass productivity and cost. Further, it is preferably a vacuum deposition method with a view to obtaining a uniform recording layer.

First Reflective Layer

The first reflective layer 103 is required to absorb a small amount of recording and retrieving light, to have a light transmittance of usually at least 40% and to have an appropriate reflectivity. For example, an appropriate transmittance can be obtained by thinly forming a metal having a high reflectivity. Further, it preferably has a certain level of corrosion resistance. Further, it preferably has barrier properties such that the first recording layer 102 is not influenced by bleeding of another component from the upper layer of the first reflective layer 103 (interlayer 104 in this case).

The thickness of the first reflective layer 103 is usually at most 50 nm, preferably at most 30 nm, more preferably at most 20 nm. Within the above range, a light transmittance of at least 40% tends to be easily achieved. However, the thickness of the first reflective layer 103 is usually at least 3 nm, preferably at least 5 nm, so that the first recording layer 102 will not be influenced by the layer present on the first reflective layer 103.

The material constituting the first reflective layer 103 is not particularly limited, and is preferably one having an appropriately high reflectivity at a wavelength of retrieving light. For the first reflective layer 103, for example, a metal or a metalloid such as Au, Al, Ag, Cu, Ti, Cr, Ni, Pt, Ta, Pd, Mg, Se, Hf, V, Nb, Ru, W, Mn, Re, Fe, Co, Rh, Ir, Zn, Cd, Ga, In, Si, Ge, Te, Pb, Po, Sn, Bi or a rare earth metal may be used alone or as an alloy.

As a method of forming the first reflective layer 103, a sputtering method, an ion plating method, a chemical deposition method or a vacuum deposition method may, for example, be mentioned.

Interlayer

The interlayer 104 is made of a transparent resin on which a concavo-convex shape such as grooves or pits can be formed and which has a high adhesive force. Further, a resin having a small shrinkage ratio at the time of curing for adhesion is preferred, with which the medium tends to have a high form stability. Further, the interlayer 104 is preferably made of a material which will not do damages to a second recording layer 105. The interlayer 104 is usually easily compatible with the second recording layer 105 in many cases. Accordingly, in order to prevent compatibilization of the interlayer 104 with the second recording layer 105 to suppress damages to the second recording layer 105, it is preferred to form a proper buffer layer between these layers. Further, a buffer layer may be formed between the interlayer 104 and the first reflective layer 103. The thickness of the interlayer 104 is preferably controlled accurately, and a thickness of usually at least 5 μm, preferably at least 10 μm is required. However, the thickness is usually at most 100 μm, preferably at most 70 μm.

On the interlayer 104, a concavo-convex shape is spirally or concentrically formed, and the concavo-convex shape forms grooves and lands. Usually, employing such grooves and/or lands as record tracks, information is recorded and retrieved on the second recording layer 105. The groove width is usually at a level of from 200 to 500 nm, and the groove depth is at a level of from 120 to 250 nm. In a case where the record tracks are in a spiral form, the track pitch is preferably at a level of from 0.1 to 2.0 μm.

As a material constituting the interlayer 104, a thermoplastic resin, a thermosetting resin or a radiation-curing resin may, for example, be mentioned. An interlayer 104 made of a thermoplastic resin, a thermosetting resin or the like is formed in such a manner that a thermoplastic resin or the like is dissolved in a proper solvent to prepare a coating liquid, which was applied and dried (heated) to form the interlayer 104. An interlayer 104 made of a radiation-curing resin is formed in such a manner that the resin as it is or a coating liquid prepared by dissolving the resin in a proper solvent is applied and cured by application of a proper radiation. Such materials may be used alone or as mixed. Further, the interlayer 104 may be formed into a multilayer film. As a coating method, a coating method such as a spin coating method or a casting method may be employed, and among them, a spin coating method is preferred. An interlayer 104 made of a high viscous resin may be formed also by coating by means of a screen printing or the like. The radiation-curable resin is preferably one in a liquid form at from 20 to 40° C. Use of the radiation-curing resin improves productivity since it can be applied without using a solvent. Further, it is preferably prepared to have a viscosity of from 20 to 4,000 mPa·s.

Among the materials of the interlayer 104, a radiation-curing resin is preferred, and among them, an ultraviolet-curing resin is preferred. When such a resin is employed, the concavo-convex shape of the light transmitting stamper is easily transcribed. The ultraviolet-curing resin may be a radical ultraviolet-curing resin (radical polymerizable ultraviolet-curing resin) and a cation ultraviolet-curing resin (cation polymerizable ultraviolet-curing resin), and both may be used. As the radical ultraviolet-curing resin, a composition containing an ultraviolet-curing compound and a photo polymerization initiator as essential components is used. As the radical ultraviolet-curing compound, a monofunctional (meth)acrylate and a polyfunctional (meth)acrylate may be used as polymerizable monomer components. These may be used alone or as a mixture of two or more of them in combination, respectively. Here, an acrylate and a methacrylate will generically be referred to as a (meth)acrylate. As the photo polymerization initiator, a molecular cleavage type or a hydrogen abstraction type is preferred. In the present invention, it is preferred that an uncured ultraviolet-curing resin precursor composed mainly of a radical polymerizable acrylate is cured to obtain an interlayer.

The cationic ultraviolet-curing resin may, for example, be an epoxy resin containing a cation polymerizable photo polymerization initiator. The epoxy resin may, for example, be a bisphenol A-epichlorohydrin type, an alicyclic epoxy, a long chain aliphatic type, a brominated epoxy resin, a glycidyl ester type, a glycidyl ether type or a heterocyclic type. It is preferred to use as the epoxy resin one having small contents of free chlorine and chlorine ions. The amount of chlorine is preferably at most 1 wt %, more preferably at most 0.5 wt %. The cation polymerizable photoinitiator may, for example, be a sulfonium salt, an iodonium salt or a diazonium salt.

Second Recording Layer

The second recording layer 105 is, similar to the above-described first recording layer 102, usually required to have a higher sensitivity than a recording layer used for an optical recording medium such as CD-R or dual DVD-R. Further, the second recording layer 105 is preferably made of a dye generating small heat and having a high refractivity so as to realize favorable recording and retrieving characteristics. Further, it is preferred that reflection and absorption of light are within proper ranges in combination of the second recording layer 105 and a second reflective layer 106. The material constituting the second recording layer 105, its formation method and the like may be the same as for the first recording layer 102. The method of forming the second recording layer 105 is preferably a wet film formation method. The thickness of the second recording layer 105 is not particularly limited since a suitable thickness varies depending upon the recording method and the like, and is usually at least 10 nm, preferably at least 30 nm, particularly preferably at least 50 nm. However, in order to obtain a moderate reflectivity, the thickness of the second recording layer 105 is usually at most 3 μm, preferably at most 1 μm, more preferably at most 200 nm. The materials used for the first recording layer 102 and the second recording layer 105 may be the same or different.

Second Reflective Layer

The second reflective layer 106 preferably has a high reflectivity and is highly durable. In order to secure a high reflectivity, the thickness of the second reflective layer 106 is usually at least 20 nm, preferably at least 30 nm, more preferably at least 50 nm. However, in order to increase the recording sensitivity, it is usually at most 400 nm, preferably at most 300 nm.

A material constituting the second reflective layer 106 is preferably one having a sufficiently high reflectivity at the wavelength of the retrieving light. As the material constituting the second reflective layer 106, for example, a metal such as Au, Al, Ag, Cu, Ti, Cr, Ni, Pt, Ta or Pd may be used alone or as an alloy. Among them, Au, Al and Ag which have a high reflectivity, are suitable as the material for the second reflective layer 106. Further, in addition to such a metal as the main component, another component may be contained. Said another component may, for example, be a metal or a metalloid such as Mg, Se, Hf, V, Nb, Ru, W, Mn, Re, Fe, Co, Rh, Ir, Cu, Zn, Cd, Ga, In, Si, Ge, Te, Pb, Po, Sn, Bi or a rare earth metal. As a method of forming the second reflective layer 106, a sputtering method, an ion plating method, a chemical deposition method or a vacuum deposition method may, for example, be mentioned. Further, a known inorganic or organic interlayer or adhesive layer may be formed on or under the second reflective layer 106 for the purpose of improving the reflectivity, improving recording characteristics, improving adhesion, etc.

Adhesive Layer

The adhesive layer 107 preferably has a high adhesion force and a small shrinkage ratio when it is cured for adhesion, whereby the medium tends to have a high form stability. Further, the adhesive layer 107 is preferably made of a material doing no damage to the second reflective layer 106. Further, in order to suppress the damage, a known inorganic or organic protective layer may be formed between these layers. The thickness of the adhesive layer 107 is usually at least 2 μm, preferably at least 5 μm. However, the thickness of the adhesive layer 107 is usually at most 100 μm so as to make the optical recording medium as thin as possible, and to overcome such a problem that curing takes long, thus decreasing the productivity. The material of the adhesive layer 107 may be the same as the material of the interlayer 104. Further, as the adhesive layer 107, a pressure sensitive double coated adhesive tape or the like may also be used. The adhesive layer 107 can be formed by sandwiching the pressure sensitive double coated adhesive tape between the second reflective layer 106 and the second substrate 108, followed by pressing.

Second Substrate

The second substrate 108 preferably has high mechanical stability and has high rigidity. Further, it preferably has high adhesion with the adhesive layer 107. As such a material, the same material as one which can be used for the first substrate 101 may be used. Further, as the above material, an Al alloy substrate of e.g. an Al—Mg alloy containing Al as the main component, a Mg alloy substrate of e.g. a Mg—Zn alloy containing Mg as the main component, a substrate made of one of silicon, titanium and ceramics, or a substrate comprising a combination thereof may, for example, be also used. The material of the second substrate 108 is preferably a polycarbonate in view of high productivity such as moldability, cost, low moisture absorption properties, form stability, etc. The material of the second substrate 108 is preferably an amorphous polyolefin in view of chemical resistance, low moisture absorption properties, etc. Further, the material of the second substrate 108 is preferably a glass substrate in view of high responsibility, etc. In order that the optical recording medium 100 has sufficient rigidity, the second substrate 108 is preferably thick to a certain extent, and the thickness of the second substrate 108 is preferably at least 0.3 mm. However, it is at most 3 mm, preferably at most 1.5 mm.

Other Layers

The optical recording medium 100 may have another optional layer sandwiched between layers as the case requires, in the above laminated structure. Otherwise, another optional layer may be formed on the outermost layer of the medium. Further, the optical recording medium 100 may have a print-receiving layer on which writing (printing) is possible by a printer such as an ink jet printer or a thermal transfer printer or by any writing instrument, on the side which is not a side where the recording light or retrieving light enters, as the case requires. Further, two optical recording mediums may be bonded so that the first substrates 101 face outside. By bonding two optical recording mediums 100, a large capacity medium having four recording layers can be obtained.

The process for producing an optical recording medium to which the present embodiment is applied can be applied to a phase change type rewritable compact disk (CD-RW, CD-Rewritable) or a phase change type rewritable DVD (tradename, DVD-RW, DVD+RW). In the phase change type CD-RW or DVD-RW, the difference in reflectivity and the change in phase difference generated by the difference in refractivity between the amorphous state and the crystalline state of the recording layer made of a phase-change type recording material are utilized to detect recording information signals. Specifically, the phase change type recording material may, for example, be a SbTe, GeTe, GeSbTe, InSbTe, AgSbTe, AgInSbTe, GeSb, GeSbSn, InGeSbTe or InGeSbSnTe type material. Among them, it is preferred to use a composition containing Sb as the main component for the recording layer so as to increase the crystallization rate.

### EXAMPLES

Now, the present embodiment will be described in further detail with reference to the following Examples. However, the present embodiment is by no means restricted to the following Examples within a range not to exceed the gist.

Light Transmitting Stampers

Disk shape light transmitting stampers each having a center hole with an inner diameter of 15 mm and having an outer diameter of 120 mm and a thickness of 0.6 mm were formed by an injection molding method using as a material a polypropylene (NOVATEC (registered trademark) PPMG05BS, manufactured by Japan Polychem Corporation), an amorphous polyolefin (ZEONOR (registered trademark) 1060R, manufactured by ZEON CORPORATION) or a polycarbonate (NOVAREX (registered trademark) 7020AD2, manufactured by Mitsubishi Engineering-Plastics Corporation). The injection molding was carried out by means of an injection molding machine (MO40D3H, manufactured by NISSEI CORPORATION) using a nickel master having guide grooves with a track pitch of 0.74 μm, a width of about 0.37 μm and a depth of about 160 nm. Principal molding conditions of each resin material are shown in Table 1. As a result of measurement by an atomic force microscope (AFM), each of the light transmitting stampers obtained by injection molding was confirmed to have guide grooves precisely transcribed from the nickel master.

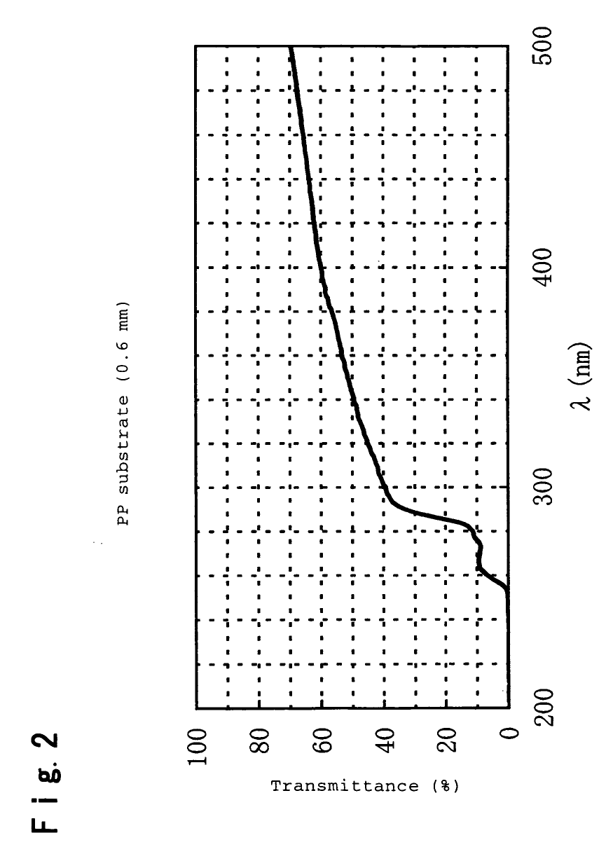

Further, FIG. 2 is a graph illustrating the result of measuring the light transmittance of the polypropylene light transmitting stamper at a wavelength of from 200 nm to 500 nm. The light transmittance was measured by means of an ultraviolet-visible spectrophotometer (V-560, manufactured by JASCO Corporation).

Peel Test of Light Transmitting Stamper

In a process for producing an optical recording medium by a 2P process, each of the above-described light transmitting stampers was disposed on an ultraviolet-curing resin material layer, and ultraviolet rays were applied to cure the ultraviolet-curing resin. Then, a knife edge was inserted at a non-coated portion of an interlayer from the center hole portion (inner diameter side) of the light transmitting stamper. Then, a force was applied to separate the light transmitting stamper and the ultraviolet-curing resin material layer. At this occasion, separation characteristics were evaluated on the basis of the following standards.

©: They are easily separated.

◯: They are separated with a certain level of force.

X: They are hardly separated.

Further, the same light transmitting stamper was repeatedly used to determine the number of times it can be used. The number of time it can be used is to evaluate the number of times the light transmitting stamper can be repeatedly used in view of separation characteristics (number of repeated use).

TABLE 1

| | | Ex. 1 | Ex. 2 | Comp. Ex. |
|---|---|---|---|---|
| Light transmitting stamper material | | Polypropylene | Amorphous | Polycarbonate |
| | | | polyolefin | |
| MFR (g/10 min.) (21.18 N) | | 45 (230° C.) | 60 (280° C.) | 15 (280° C.) |
| Mold temperature | Mirror surface at the | 60 | 89 | 130 |
| (° C.) | master side | | | |
| | Mirror surface at the | 55 | 88.5 | 127 |
| | side opposite to the | | | |
| | master | | | |

| | | | |
|---|---|---|---|
| Resin temperature (° C.) | 270 | 350 | 385 |
| Injection rate (cm³/s) | 60 | 100 | 130 |
| Clamp force (ton) | 35 | 35 | 30 |
| Cooling time (sec) | 7 | 8 | 7 |
| Separation characteristics | ⊚ | ◯ | X |
| Number of repeated use | 5 | 3 | — |

### Examples 1 and 2

An interlayer was formed on a reflective layer formed by a sputtering method on a disk shape substrate having a center hole with an inner diameter of 15 mm and having an outer diameter of 120 mm. The interlayer was formed as follows.

On the reflective layer, 2.5 g of an uncured ultraviolet-curing resin precursor (viscosity: 1,200 mPa·s) composed mainly of a radical polymerizable acrylate was dropped on a position corresponding to an inner diameter of 25 mm in a circular shape, and then stretched by rotation at a number of revolutions of 3,500 rpm for 15 seconds to form an ultraviolet-curing resin material layer.

Then, using the above-described polypropylene light transmitting stamper (Example 1) or amorphous polyolefin light transmitting stamper (Example 2), the light transmitting stamper and the substrate were bonded under evacuation so that the guide grooves of the light transmitting stamper and the surface having the ultraviolet-curing resin material layer formed thereon faced each other. Then, in a nitrogen atmosphere, a metal halide lamp was applied from the light transmitting stamper side to cure the ultraviolet-curing resin thereby to form an interlayer. The illuminance and the integrated amount of light of the ultraviolet rays were 216 mW/cm² and 1,092 mJ/cm², respectively, as measured at a wavelength of 365 nm.

Then, in accordance with the above-described method, the peel test of the light transmitting stamper was carried out to measure the separation characteristics and the number of repeated use of the polypropylene light transmitting stamper and the amorphous polyolefin light transmitting stamper. The results are shown in Table 1.

It is found from the results shown in Table 1 that the light transmitting stamper and the ultraviolet-curing resin can easily be separated when the interlayer is formed by a 2P process by using the polypropylene light transmitting stamper (Example 1) or the amorphous polyolefin light transmitting stamper (Example 2). Further, it is found that these light transmitting stampers can be repeatedly used. When the surface of the interlayer formed from the ultraviolet-curing resin was observed by an AFM, it was confirmed that the guide grooves were precisely transcribed from the light transmitting stamper.

### Comparative Example

Using the above-described polycarbonate light transmitting stamper, the ultraviolet-curing resin was cured and the peel test of the light transmitting stamper was carried out in the same manner as in Example 1.

As evident from the results shown in Table 1, the polycarbonate light transmitting stamper and the ultraviolet-curing resin could hardly be separated, and they were not separated even when a great force was applied by a knife edge, and the polycarbonate light transmitting stamper was cracked and broken.

### Example 3

On a disk-shape substrate having a center hole with an inner diameter of 15 mm and having an outer diameter of 120 mm, a recording layer and a reflective layer were formed by a spin coating method and a sputtering method, respectively. Then, on the reflective layer, 2.3 g of an uncured ultraviolet-curing resin precursor (viscosity: 260 mPa·s) composed mainly of a radical polymerizable acrylate was dropped on a position corresponding to an inner diameter of 25 mm in a circular shape and stretched by rotation at a number of revolutions of 4,000 rpm for 6 seconds to form an ultraviolet-curing resin material layer.

Then, using a disk-shape amorphous polyolefin light transmitting stamper having a center hole with an inner diameter of 15 mm and having an outer diameter of 120 mm (a light transmitting stamper similar to one used in Example 2), the light transmitting stamper and the substrate were bonded under evacuation so that the guide grooves of the light transmitting stamper and the surface having the ultraviolet-curing resin material layer formed thereon faced each other. Then, in a nitrogen atmosphere, a high pressure mercury lamp was applied from the light transmitting stamper side to cure the ultraviolet-curing resin thereby to form an interlayer. The illuminance of the ultraviolet rays was 85 mW/cm² as measured at a wavelength of 365 nm.

After formation of the interlayer, an outer burr (a burr in a perpendicular direction at the edge of the ultraviolet-curing resin) was generated, and it was attempted to remove this portion by laser trimming by means of a CO₂ gas laser manufactured by KEYENCE CORPORATION. However, it was given up since the outer burr was very small. Then, as shown in FIG. 9, the peel test of the light transmitting stamper was carried out, whereupon the light transmitting stamper could be favorably separated. After separation of the light transmitting stamper, adhesion of the outer burr was observed on the light transmitting stamper side. As a result of measurement of the size of the outer burr, it was so large as 80 μm. The size of the outer burr was measured by means of TENCOR profiler manufactured by KLA-Tencor Corporation.

### Example 4

An interlayer was formed in the same manner as in Example 3 except that the shape of the light transmitting stamper was a disk shape having a center hole with an inner diameter of 15 mm and having an outer diameter of 124 mm.

After formation of the interlayer, a CO₂ laser was applied along the outer diameter of the interlayer at a position corresponding to an outer diameter of 120 mm by means of a CO₂ gas laser manufactured by KEYENCE CORPORATION to carry out laser trimming.

Then, the peel test of the light transmitting stamper was carried out, whereupon the light transmitting stamper could be favorably separated. Further, the size of an outer burr (a burr in a vertical direction at the edge of the ultraviolet-curing resin) adhering to the light transmitting stamper was measured. As a result, a very small burr of 4 μm was observed. Further, the edge of the interlayer was kept favorable.

### INDUSTRIAL APPLICABILITY

According to the present invention, the production efficiency of a laminated multilayer optical recording medium by a 2P process will improve.

The present invention has been described in detail with reference to specific embodiments, but it is apparent to those skilled in the art that various changes and modifications are possible without departing from the concept and scope of the present invention.

The present application is based on a Japanese Patent Application (JP2003-382292) filed on Nov. 12, 2003, and the entire disclosure thereof is hereby included by reference.

What is claimed is:

1. A process for producing an optical recording medium, which comprises:
a step of forming a recording layer on which information is to be recorded by applied light, on a substrate directly or via another layer,
a step of forming a resin material layer on the formed recording layer directly or via another layer, and
a step of disposing a light transmitting stamper comprising a nonpolar member having a concavo-convex shape on the formed resin material layer and separating the light transmitting stamper so that the concavo-convex shape is transcribed to the resin material layer to form an interlayer.

2. The process for producing an optical recording medium according to claim 1, wherein the nonpolar member is a polymer material having no polar group in its molecule.

3. The process for producing an optical recording medium according to claim 1, wherein the nonpolar member is a polyolefin.

4. The process for producing an optical recording medium according to claim 3, wherein the polyolefin is a crystalline polyolefin.

5. The process for producing an optical recording medium according to claim 1, wherein the nonpolar member is a polypropylene.

6. The process for producing an optical recording medium according to claim 1, wherein the light transmitting stamper is made of a nonpolar polymer material having a melt flow rate (MFR) in a molten state of at least 20 g/10 min.

7. The process for producing an optical recording medium according to claim 1, wherein the outer diameter of the light transmitting stamper is larger than the outer diameter of the substrate.

8. The process for producing an optical recording medium according to claim 7, wherein the outer diameter of the light transmitting stamper is larger than the outer diameter of the substrate by a range of at least 1 mm and at most 15 mm.

9. The process for producing an optical recording medium according to claim 1, wherein another resin material layer different from the above resin material layer is formed on the surface having the concavo-convex shape of the light transmitting stamper and the light transmitting stamper is disposed so that said another resin material layer and the resin material layer formed on the recording layer directly or via another layer face each other.

10. The process for producing an optical recording medium according to claim 1, wherein the resin material layer is made of a radiation-curing resin.

11. The process for producing an optical recording medium according to claim 10, wherein before the light transmitting stamper is separated, light is applied to the resin material layer so that the radiation-curing resin in the resin material layer is cured to form the interlayer.

12. The process for producing an optical recording medium according to claim 1, wherein when the interlayer extends beyond the outer diameter of the substrate, the interlayer portion extending beyond the outer diameter of the substrate is removed.

13. The process for producing an optical recording medium according to claim 12, wherein the interlayer portion extending beyond the outer diameter of the substrate is removed by application of a laser beam.

14. The process for producing an optical recording medium according to claim 1, wherein a knife edge is inserted between the substrate and the light transmitting stamper to separate the light transmitting stamper.

15. The process for producing an optical recording medium according to claim 14, wherein the substrate and the light transmitting stamper have a planar circular shape, and the knife edge is inserted from the inner diameter side of the substrate and the light transmitting stamper.

16. The process for producing an optical recording medium according to claim 14, wherein the thickness of the light transmitting stamper is made thin at a portion where the knife edge is inserted.

17. The process for producing an optical recording medium according to claim 1, which further comprises a step of forming another recording layer on which information is to be recorded by applied light, on the interlayer on which the concavo-convex shape is transcribed, directly or via another layer.

18. A light transmitting stamper to be used for a process for producing an optical recording medium comprising a step of forming an interlayer by a photo polymerization process, which is formed from a nonpolar member having a transmittance of a light having a wavelength of from 300 nm to 400 nm of at least 10%.

19. The light transmitting stamper according to claim 18, which has a thickness of from 0.3 mm to 5 mm.

20. The light transmitting stamper according to claim 18, which has an outer diameter larger than the outer diameter of the optical recording medium.
